(19) United States
(12) Patent Application Publication
(10) Pub. No.: US 2008/0260351 A1
(43) Pub. Date: Oct. 23, 2008

(54) Recording of Protected Broadcast Content with Selectable User Rights

(75) Inventors: Hong Li, Eindhoven (NL); Albert Maria Arnold Rijckaert, Waalre (NL); Milan Petkovic, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,058

(22) PCT Filed: Dec. 14, 2006
(86) PCT No.: PCT/IB2006/054852

§ 371 Date: Jun. 19, 2008

(30) Foreign Application Priority Data
Dec. 22, 2005 (EP) 05301093.0

(51) Int. Cl. H04N 5/91

(52) U.S. Cl. 386/94; 386/E05.004

(57) ABSTRACT

An apparatus for recording a signal having a signal content, where the apparatus comprises a receiver for receiving the signal, a processor configured to determine rights to the signal content received with the received signal, and a recorder for recording the received signal and a signal representing the determined rights to the signal content, wherein the processor is configured to give, to right holders, individual rights to the content respecting the determined rights to the content. A user who receives the signal can give individual rights to right holders respecting the rights to the content. The given rights comprise full rights and restricted rights such as owner rights corresponding to the rights to the content received with the received signal, and user rights that allow the right holder to use, such as view, the signal content. Use of the individual rights requires a corresponding individual key.

### FIELD OF THE INVENTION

This invention relates to recording by a receiver of broadcast content, in particular digital content such as video programs, where the broadcast content is protected e.g. by copyright or other rights or restrictions imposed by the broadcaster.

### BACKGROUND OF THE INVENTION

Nowadays there are several protection concerns related to recording digital content. There are several types of protected broadcast signals. The types that will be considered here are conditional access signals like Canal+ and signals protected by the Broadcast flag in the USA. When the Broadcast flag is set, the signal may still be recorded but no longer copied or distributed by the user. For conditional access signals it is assumed that the signal may be recorded after the decryption of the signal but that further copying or distribution is not allowed. This could also be more dynamic by a wider interpretation of the Macrovision flag. In this case the Macrovision flag is used in the same way as the Broadcast flag. These protections are used for copyrights.

On the other hand, consumers take their privacy more seriously, not only for their private content but also for their behaviour of entertainment with all kinds of content. An embodiment of the invention is a privacy-preserved home system that allows consumers to protect their content and to share the content with others in a controlled way. This is achieved by using cryptography and distinguishing between the owner and the user of a data item: the user has a certain usage rights to the content, such as ‘Viewing’; while the owner has the rights to manage the content, such as granting viewing rights to others, editing the content and destroy the content. This protection is person-based. It allows a user to access the content using multiple compliant devices. Because only persons with the granted rights can access the content, it is not a real issue of copyrights where the encrypted content is and how many copies there are.

While enjoying the convenience provided by a personal video recorder (PVR), consumers also worry about exposing children to ‘adult content’ since the recorded content is easy accessible at any moment.

U.S. Pat. No. 6,564,005 describes a multi-user hard disk recorder, which claims the methods for providing multiple users with the video recording and playback functions. It allows master users to manage user accounts and set profiles for users to limit their recording or viewing capabilities. A recording can be saved as protected with a password. However, this patent neither claims any method to really protect private recordings nor describes recording of protected broadcasting.

When a content item is recorded and locked to a device by encryption, e.g. in the case with the Broadcast flag in the USA, it is not possible for consumers to view the recording using other devices via the home network. Moreover, the encrypted content is visible by any person who uses the device. This neither protects privacy nor limits the access to adult content. It may be better to record the content in a person-based protection, e.g. only the parents have the viewing rights to a copy-protected content item.

However, there is another issue in achieving this person-based protection for programmed recording. Because a PVR allows users to set recording requests days before the broadcast (for example by using keywords like a name of an actor), it is normal that the user is not online when the system starts the recording. This creates a problem for the recording device, because generating a private recording requires the secret of the user to correctly create the owner rights for the private recording. The invention addresses these problems.

### OBJECT AND SUMMARY OF THE INVENTION

It is preferred to have a device with more flexible conditional access features than the prior art allows. Therefore, the invention provides an apparatus for recording a signal having a signal content, where the apparatus comprises a receiver for receiving the signal, a processor configured to determine rights to the signal content received with the received signal, and a recorder for recording the received signal and a signal representing the determined rights to the signal content, wherein the processor is configured to give, to right holders, individual rights to the content respecting the determined rights to the content.

Other embodiments of the invention are a method with corresponding method steps, a computer program product and a computer readable record carrier with the computer program recorded thereon, which comprise instructions to be carried out on a programmable apparatus such as a computer and for causing the computer to control and perform the method of the invention.

With the invention the received signal can be recorded with owner rights, which are full rights with no further restrictions than the rights protecting the received signal while still respecting such rights. Owner rights allows the rights holder to further delegate and share the content with others, and user rights that are further restricted rights may be given to other individuals or devices, whereby a user has the right to use the content but no right to distribute the content and to give rights to others. User rights are thus restricted to use of the content. The invention thus proposes a method of recording content with a hierarchy of protection levels using the owner and user concept, so that consumers can access the encrypted records easily with home devices and share them with selected persons. If desired the hierarchy of protection can have any number of levels higher than or equal to two.

The method is secure and in line with requirements posed by the content-industry. In a typical application of the invention the content is a video program, but the invention is also useful for administering rights to other content such as music, video games and computer software. In case of a video program the user can view the video program, and in case of a computer program the user may use the program.

In one embodiment the method of the invention comprises determining rights to the signal content received with the signal, and giving individual rights to right holders respecting the rights to the content, and recording the received signal and a signal representing the rights to the content. A user who receives the signal can give individual rights to right holders respecting the rights to the content. The given rights comprise full rights and restricted rights such as owner rights corresponding to the rights to the content received with the received signal, and user rights that allow the right holder to use, such as view, the signal content.

Among the advantageous features of the invention are the following:

A user can see an indication of the protection level or category for the recording when he sets or views the programmed schedule of the recording, according to the knowledge the system has at the moment about the protection of the broadcast channels.

If allowed by the protection level set by broadcaster, a user can choose or change the protection level or category when he sets or views the schedule, e.g.:

Select who is the user: only he himself (private), or selected family or group members, or the whole family or group.

Select who is the owner: he himself or the family or other group, if the broadcast allows,

Whenever the system detects the broadcast signal of protection during a recording, the system can enforce the device as the owner of the recording, and the previous owner stated in the recording request will be the sharing user of this content.

If required by the broadcaster, the system can enforce the device as the owner and user of the recorded content, so that everyone can use only this device to access the content.

Other persons who do not have rights to the recording have no access to the content. They even do not know the existence of the recording.

A user can access the protected recordings on compatible devices, as long as he has owner or user rights to the recordings.

The device ensures that the programmed recording is completed in a secure way. Only persons who have rights, can access the recording, others even do not know the existence of the recording.

### BRIEF DESCRIPTION OF THE DRAWINGS

FIG. 1 shows schematically an embodiment of a physical key used with the invention,

FIG. 2 shows schematically an embodiment of a secure subsystem used with the invention, and

FIG. 3 shows a general purpose computer and a record carrier for performing the method of the invention.

### DESCRIPTION OF EMBODIMENTS

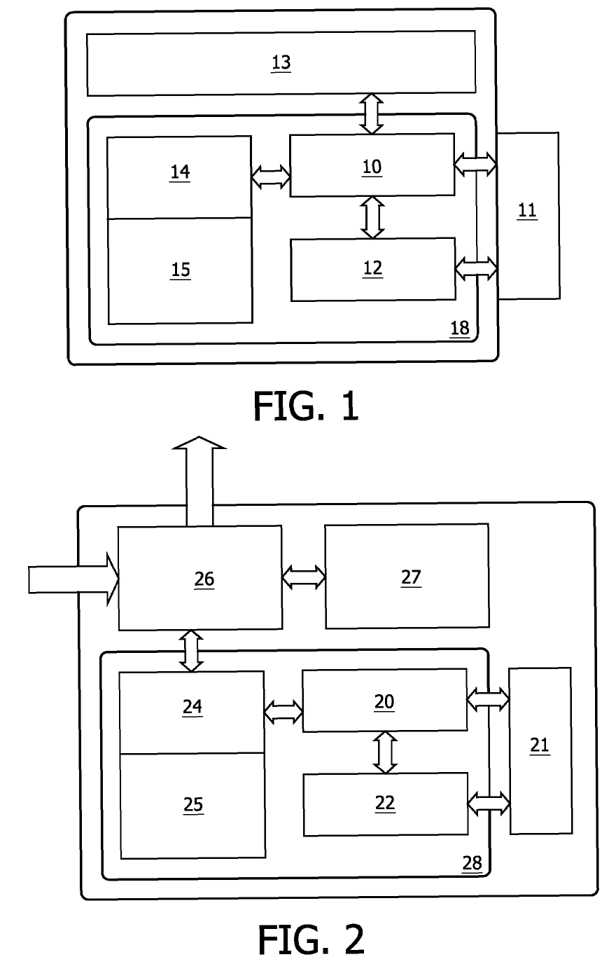

The physical key illustrated in FIG. 1 comprises a cryptographic processor 10, which can communicate with a physical key interface 11 of the physical key either directly or via a secure channel 12. The physical key has an embedded main memory 13 and an access message processing block 18 with a secure memory with a secure volatile memory 14 and a secure non-volatile memory 15.

Like the physical key in FIG. 1 the secure subsystem illustrated in FIG. 2 has a cryptographic processor 20, which can communicate with a physical key interface 21 of the secure subsystem either directly or via a secure channel 22. The secure subsystem also has an access message processing block 28 with a secure memory with a secure volatile memory 24 and a secure non-volatile memory 25. The secure volatile memory 24 can communicate with a content encrypter and decrypter 26 in communication with a second secure volatile memory 27. The content encrypter and decrypter 26 can receive and encrypt non-encrypted content and output encrypted content to be recorded, and the content encrypter and decrypter 26 can receive and decrypt recorded encrypted content and output decrypted content to be viewed by a user.

In an embodiment of the invention, content is protected in a two-layer protection model: each protected content item is encrypted with a symmetric cipher, or the so-called asset key. An asset key is encrypted in access messages. Each user of the content item has one access message, in which the asset key and the usage rights are in one block encrypted with the public key of the user, and in another block encrypted with the public key of owner. The message is signed using the private key of the content owner. In this way, only the user can access the content according to the rights in the access message, and only the owner can check and modify the rights that he has granted to the user.

An embodiment of the invention uses a secure subsystem and a physical key to secure the two-layer protection model. The physical key contains the private key of the user and the private key of the family or group in its tamper-proof secure memory. It is the device to handle the access messages. The secure subsystem can encrypt or decrypt the content using the asset key received from the physical key via a secure channel. When a user wants to access his private content through a terminal, it requires the user's Physical key and a secure subsystem to decrypt his access message and the content.

In an embodiment of the invention, content is handled in three categories: the public content, the family content and the private content. Public content is not protected. Family content is sensitive for the privacy of the family or group, but shared within the family or group. It is protected and the family or group members have the key, i.e. the Family Private Key in their physical keys, to access and manage the family content. The private content is personally protected and only the right person can access the content using his physical key.

The individual physical key in FIG. 1 is a tamper-resistant device. It may be embedded in a mobile device, e.g. a key-ring MP3 player or a mobile phone. The physical key is not only a user identity for authentication; it is a private rights manager for a person to handle his content on certain embodiments of the invention. The secure memory blocks 14 and 15 are only accessible by the cryptographic processor 10 for processing key-pairs and access message. The outside world should not be able to access them and modify them. The secure non-volatile memory 15 is used for storing the key-pair of the physical key owner, i.e. the unique personal key-pair of key owner which is different from all other physical keys. This key-pair is used for authentication of the physical key, and the person. Note that the private key of the personal key-pair must never be exposed outside the processing block. It is even a secret to the owner of the physical key. Likewise, the family or group key-pair is stored in the non-volatile memory of a physical family key. The secure channel 12 is used to communicate safely with the secure subsystem for asset keys and family private key. Using the personal key-pair the cryptographic processor 10 can set up and use the secure channel 12. It is able to verify, create, decrypt and sign the access messages, depending on the rights in the access messages. The cryptographic processor 10 uses the physical key interface 11 for system control, sending and receiving access messages and so on. The embedded main memory 13 is not necessary for the major physical key functions (i.e. authentication, access message processing, family key-pair, etc.), however it is useful to have more space for data, e.g. the access messages, the public keys of others, the usage history and even application data and content. The cryptographic processor 10 does not need high performance, since it handles only short access messages. If high throughput is required for accessing the embedded main memory 13, the physical key interface needs another direct access to the main memory.

The secure subsystem is inside an embodiment of the invention. It has a content cryptographic processor 20, secure volatile memory 24, a secure access message processing block 28, a physical key interface 21, and interfaces to the rest of the embodiment of the invention. The secure subsystem takes key roles in the embodiment of the invention for privacy protection, including the content encrypter and decrypter 26, device authentication, interfacing and using physical keys, and the residential privacy-enhancing processor for scheduled private recording/importing and other functions.

The secure subsystem in FIG. 2 and the physical key in FIG. 1 can use identical hardware with slightly different firmware. The secure non-volatile memory 15 of the secure subsystem stores a device key-pair (instead of the personal key-pair in the physical key), which is unique to other embodiments of the invention and physical keys. The device key-pair is used for device authentication, setting up the secure channel 22, and for functions like scheduled private recording when the personal physical key is not present. The secure non-volatile memory 15 also stores the family public key so that it can verify the physical keys of the family. It may store other public keys for recognizing registered apparatus according to an embodiment of the invention, physical keys or users. The secure volatile memory of the access message processing block 28 stores the family private key in the family mode. When a family user has plugged in his physical key and been authenticated, the private key is copied from the physical key. Then, after the physical key is plugged off, the family mode is switched on. Thus, the cryptographic processor 20 in the access message processing block 28 uses the family private key to handle access messages of family content. The family private key is removed automatically in power-off or by an explicit command by a family user. Then the family mode is switched off, and family content is not accessible. The cryptographic processor 20 in the block handles the access messages of the family content in the family mode, and the access messages for scheduled private recording. It also takes care of device authentication, communication with the physical key and control of the secure channel and the control of the secure subsystem. The secure channel is used in the private mode to receive asset keys from the physical key, and to pass the asset key to the content encrypter or decrypter. The communication between the access message processing block 28 and the content cryptographic processor 20 is about the asset keys and the control of the encrypter and decrypter.

The content cryptographic processor 26 acts as content encrypter and decrypter. It needs higher performance than the access message cryptographic processor 20. It uses a secure volatile memory 24 to store the asset key and to process content data blocks. It has fast interface to other components in the apparatus of the invention to receive content data and to send processed content data.

The secure subsystem has also interfaces to other components of the apparatus of the invention for control and for access messages. The access messages are sent to/from the cryptographic processor 20 in the secure access message processing block 28 for the family content in the family mode, or in a situation that the required physical key is not present.

This invention proposes a method of letting a user see an indication of the protection categories of a programmed recording schedule, and of letting the user choose the protection category. The system also indicates the (potential) protection restriction of the broadcast if the system has the knowledge, such as from the broadcast signals (e.g. conditional access system) or Electronic Program Guide metadata.

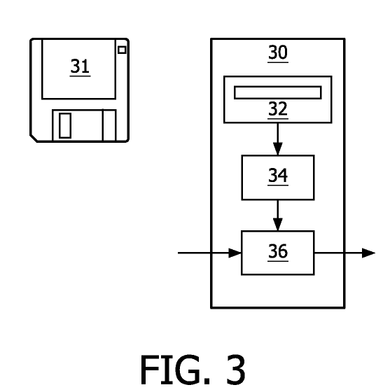

The method can also be carried out on a general-purpose computer like the personal computer 30 as shown in FIG. 3. FIG. 3 also shows a record carrier 31 comprising a computer program product for programming the personal computer 30 to perform the method according to the invention. To this, the record carrier 31 is inserted in a disk drive 302 comprised by the personal computer 30. The disk drive 32 retrieves data from the record carrier 310 and transfers it to the microprocessor 34 to program the microprocessor 304. The programmed microprocessor 34 controls a media processor 36 to perform the method according to the invention when retrieving data from the disk drive 32 when rendering audio-visual data at high speeds.

Though the record carrier 31 is depicted as a floppy disk, the record carrier 31 can also be embodied in any other suitable way known to a person skilled in the art, including, without limitation, a Compact Disc®, a CDROM, a DVD, a solid state memory card or any other optical, magnetic, opto-magnetic, non-volatile or volatile memory, including a remote server-based memory from which the computer program product can be downloaded.

When the user enters a schedule in the programmed recording schedules, he sees the options of protection categories/levels, such as who shall be granted the rights to see this recording and who can grant further sharing rights to other family member or other users.

If the broadcast channel is protected e.g. by the CA system, the system will prohibit the user to further share the recording to others. The system shows that the user will have no owner rights but only sharing rights to the recording. The system warns the user that he cannot further share this recording to others when the recording is made, but in the schedule he can choose who has sharing/viewing rights to the recording, such as:

He is the only sharing user (i.e. private shared content); or

The whole family is the sharing user (i.e. family shared content); or

He and some other people (e.g. privately shared with adults) have sharing rights to view the recording;

The system may limit the possible sharing user in the schedule (e.g. only being the family members) if the broadcaster requires this.

If the broadcast channel is not protected, the user may choose who is to be the owner of the recording, and he can grant sharing rights to other people. Thus, he can choose:

He is the owner, so the recording is his private recording;

The family or group is the owner of the recording, which allows each family or group member to manage the recording such as granting sharing rights and deleting the recording;

Everyone is the owner, which means the recording is not protected.

Again, he can choose if he is the only (private) user or other people should have sharing rights to view the recording, as mentioned before. In the case that the program could actually be broadcasted with the Macrovision flag or the Broadcast flag, which is unknown when the recording schedule is made, the system will warn the user that he will have no owner rights but only sharing user rights to the recording if one of the protection flags is detected during the recording.

The person, who creates the recording schedule/request, may see and modify the schedule, including the protection levels or categories, before the recording is started.

Whenever a protected recording request is made, the request owner may prefer that the recording is not visible to others: content is encrypted immediately and only the users who have rights can access it. But during the recording, the physical key of the request owner is often not available in the system.

This invention assumes that the recorder has an embedded access message processing block 28 (e.g. the secure subsystem in FIG. 2 that can generate access messages or rights objects) with its own unique public-private key pair. This key pair identifies the system user (i.e. the device) that owns the recording function. The invention proposes the following method to securely execute the programmed schedule and create the recording in the selected protection level.

Using the recording request that includes the public key of the request owner, the device (e.g. the secure subsystem) will create the recordings as shared private content, with the device itself as the owner and the recording request owner as the user. This means the secure subsystem creates the asset key and uses that key to encrypt the content, and generates an access message for the content with the device as the owner and the request owner as the user. If the recording is a private recording for the request owner, the usage rights to the request owner includes transfer ownership flag. The ownership will then be transferred to the request owner when he logs on the device.

For private recording the device itself is not a user in order to prevent other people from misusing the device to view the content. The playability of content is only granted to the user and not to the owner. Note that a content owner of the concept in accordance with the invention normally also possesses an access message in which he is not only the owner but also the user, which allows him to play the content. But in this case the content is only playable by the request owner and not by anybody else, not even the device itself who is the owner. The device grants an ownership transfer to the request owner by setting the transfer ownership flag in the sharing access message. The embedded access message processor generates the necessary asset key and constructs the access message when the recording starts. The ownership of the content is transferred to the request owner by means of his physical key as soon as it is detected, even if the requested recording is still in progress. This allows for time-shift, which means that the content is already played before the recording is finished. Although the ownership is already transferred while the recording is not finished yet, there is no discontinuity in the recording because the asset key in the encrypter is not changed. The same is true if the physical key is removed before the recording is finished. Also in this case the asset key in the encrypter is unchanged. This asset key is only destroyed at the end of the recording. For privacy and security reasons, the requests in the recording schedule should be protected. They can either be stored in a secure database or encrypted and signed by the public and private key of the device.

For protected broadcast signals, the recording method of this invention is performed in the same way as presented above: with the device as owner and the person who scheduled the recording as user, but the transfer ownership flag is set in accordance to the broadcast (or Macrovision) flag. If the Broadcast flag is set, the transfer ownership flag is not set and vice-versa. If conditional access providers do not allow such a reaction to the Macrovision flag, the system will stop the recording.

If a recording is made as protected content, the user can still view it as often and as long as he likes in the presence of his physical key, but he cannot become an owner and therefore not share the content with other people. The rights in the access message could set a time limit, but it is assumed that such a time limit is not applied for this case. The encrypted content and its access message can still be copied to numerous places for the convenience of the user without any deviation from the original intention, namely that the content cannot be published to the world. The user is the only one that can view it by means of his physical key although in several places. He can even view it in a secure way from a distant location via an insecure network connection. On the other hand, if the recording is made as unprotected content, the user will become an owner as soon as his physical key is inserted in the system. This allows for further sharing of this content. It will be clear that, although the content is recorded as protected or unprotected from a broadcast point of view, it is always privacy protected.

The fact that the recording device will always remain the content owner for protected broadcast content might give the impression that the content is only playable on that device. This is however not the case. The ability to view the content is only given by the user identification. This means that the content can be freely copied to other devices without any restrictions on the playability assuming the presence of the correct physical key at the playback device.

The advantage of such a scheme for conditional access signals compared to the direct recording of such signals is that on the one hand the signal is well protected against illegal copying, while on the other hand there is no problem with expiring conditional access keys. This means that the recorded conditional access content is playable forever, even if the subscription is cancelled.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

Furthermore, the invention may also be embodied with less components than provided in the embodiments described here, wherein one component carries out multiple functions. Just as well may the invention be embodied using more elements than depicted in the Figures, wherein functions carried out by one component in the embodiment provided are distributed over multiple components.

A person skilled in the art will readily appreciate that various parameters disclosed in the description may be modified and that various embodiments disclosed and/or claimed may be combined without departing from the scope of the invention. When data is being referred to as audiovisual data, it can represent audio only, video only or still pictures only or a combination thereof, unless specifically indicated otherwise in the description of the embodiments.

It is stipulated that the reference signs in the claims do not limit the scope of the claims, but are merely inserted to enhance the legibility of the claims.

A person skilled in the art will readily appreciate that various parameters disclosed in the description may be modified and that various embodiments disclosed and/or claimed may be combined without departing from the scope of the invention.

### LIST OF REFERENCE NUMERALS USED IN THE DRAWINGS:

10: cryptographic processor

11: physical key interface

12: secure channel

13: embedded main memory

14: secure volatile memory

15: secure non-volatile memory

18: access message processing block

20: cryptographic processor

21: physical key interface

22: secure channel

24: secure volatile memory

25: secure non-volatile memory

26: content encrypter and decrypter

27: secure volatile memory (asset keys)

28: access message processing block

30: personal computer

31: record carrier

32: disk drive

34: microprocessor

36: media processor

1. An apparatus (30) for recording a signal having a signal content, the apparatus (30) comprising
a receiver (26) for receiving the signal having a signal content,
a processor (28) configured to determine rights to the signal content received with the received signal, and
a recorder (32) for recording the received signal and a signal representing the determined rights to the signal content,
wherein the processor (28) is configured to give, to right holders, individual rights to the content respecting the determined rights to the content.

2. An apparatus according to claim 1 wherein the individual rights comprise owner rights corresponding to the rights to the content received with the received signal.

3. An apparatus according to claim 1 wherein the individual rights comprise user rights that are restricted relative to the owner rights.

4. An apparatus according to claim 3 wherein the user rights allow the right holder to use, such as view, the signal content.

5. An apparatus according to claim 1 wherein use of the individual rights requires a corresponding individual key.

6. An apparatus according to claim 5 wherein the individual key is a physical key.

7. An apparatus according to claim 1 wherein a right holder is a person.

8. An apparatus according to claim 1 wherein a right holder is a device.

9. A method for recording a signal having a signal content, the method comprising
receiving the signal,
determining rights to the signal content,
recording the received signal and a signal representing the determined rights to the signal content, and
giving, to right holders, individual rights to the content respecting the determined rights to the signal content.

10. A computer program product comprising instructions to be carried out on a programmable apparatus (30) and for causing
a receiver (26) to receive a signal having a signal content,
determining rights to the signal content,
recording the received signal and a signal representing the determined rights to the signal content, and
giving, to right holders, individual rights to the content respecting the determined rights to the signal content.

11. A computer readable record carrier (31) having stored thereon a computer program comprising instructions to be carried out on a programmable apparatus and for causing
a receiver to receive a signal having a signal content,
determining rights to the signal content,
recording the received signal and a signal representing the determined rights to the signal content, and
giving, to right holders, individual rights to the content respecting the determined rights to the signal content.
